(19) United States
(12) Patent Application Publication
(10) Pub. No.: US 2014/0037039 A1
(43) Pub. Date: Feb. 6, 2014

(54) Fuel Assembly and Reactor Core

(71) Applicant: Hitachi-GE Nuclear Energy, Ltd., Hitachi-shi (JP)

(72) Inventors: Takeshi MITSUYASU, Hitachi-shi (JP); Motoo AOYAMA, Mito-shi (JP); Takuji NAGAYOSHI, Hitachi-shi (JP); Kenichi KATONO, Hitachi-shi (JP)

(73) Assignee: Hitachi-GE Nuclear Energy, Ltd., Hitachi-shi (JP)

(21) Appl. No.: 13/956,082

(22) Filed: Jul. 31, 2013

(30) Foreign Application Priority Data
Aug. 3, 2012 (JP) 2012-172929

(51) Int. Cl. G21C 3/328

(52) U.S. Cl. CPC G21C 3/328
USPC 376/435

(57) ABSTRACT

A fuel assembly with a plurality of fuel rods, extending along a uniform direction, disposed inside a channel box assuming a quadrangular duct shape, wherein: the plurality of fuel rods that are disposed on sides of a plurality of hypothetical concentric quadrangles of various sizes with shapes similar to a cross-sectional shape of the channel box viewed from an end along which the fuel rods extend, and include at least outermost fuel rods disposed on the sides of a largest hypothetical concentric quadrangle among the hypothetical concentric quadrangles and second layer fuel rods disposed on the sides of a second largest hypothetical concentric quadrangle among the hypothetical concentric quadrangles; and the outermost fuel rods are disposed so that consecutive outermost fuel rods are set apart from each other over equal intervals which are greater than intervals setting apart consecutive fuel rods among the second layer fuel rods.

### INCORPORATION BY REFERENCE

The disclosure of the following priority application is herein incorporated by reference:
Japanese patent application no. 2012-17292 filed Aug. 3, 2012

### BACKGROUND OF THE INVENTION

1. Field of the Invention

The present invention relates to a fuel assembly used in a nuclear reactor and a reactor core loaded with the fuel assembly.

2. Description of Related Art

Numerous fuel assemblies, each configured by housing a fuel bundle in a channel box assuming an elongated quadrangular shape, are disposed in the reactor core of a boiling water reactor. The fuel bundle includes numerous fuel rods, each having a plurality of fuel pellets containing uranium sealed therein, an upper tie-plate that supports the fuel rods at their upper ends, a lower tie-plate that supports the fuel rods at their lower ends and fuel spacers that hold the fuel rods over specific intervals. Under normal circumstances, non-boiling water is present outside the channel box within the reactor core with water boiled by heat generated at the fuel rods present within the channel box.

The reaction probability with which neutrons generated from nuclear fuel react with fissile material normally increases as the neutrons become decelerated by water. Thus, fuel at a location close to water that is not boiling tends to be consumed more rapidly than fuel at a location closer to boiling water. This means that a fuel rod disposed at an outermost edge so as to directly face an inner wall of the channel box (hereafter referred to as an outermost fuel rod) achieves greater output and that the thermal margin pertaining to the heat removal from such an outermost fuel rod is bound to be smaller than that from a fuel rod disposed toward the center of the fuel assembly. Among outermost fuel rods, the fuel rods located near the four corners, in particular, are subject to the influence of the non-boiling water and thus, the output of such fuel rods tends to be especially high. Accordingly, Japanese laid open patent publication no. H4-265894 discloses a fuel assembly assuring improved heat removal performance achieved by, for instance, modifying the positional layout of the fuel rods.

### SUMMARY OF THE INVENTION

In the fuel assembly disclosed in the patent literature cited above, fuel rods are disposed within the channel box with a plurality of different fuel rod pitches so as to assure reliable heat removal performance by allowing wider fuel rod pitch near the four corners. However, a greater fuel rod pitch assumed near the corners requires that fuel rods (outermost fuel rods), which are to take up positions that directly face the channel box in areas other than the corners, be disposed with a narrower fuel rod pitch, and as a result, the heat removal performance at these fuel rods is bound to be lower. This, in turn, is likely to limit the areas where the fissile material can be loaded in greater quantities in the vicinity of the corners. Improved heat removal performance at outermost fuel rods ultimately leads to an improvement in the thermal margin of a fuel assembly with the fissile material loaded in the outermost fuel rods in greater quantities.

According to the 1st aspect of the present invention, a fuel assembly with a plurality of fuel rods, extending along a uniform direction, disposed inside a channel box assuming a quadrangular duct shape, wherein: the plurality of fuel rods that are disposed on sides of a plurality of hypothetical concentric quadrangles of various sizes with shapes similar to a cross-sectional shape of the channel box viewed from an end along which the fuel rods extend, and include at least outermost fuel rods disposed on the sides of a largest hypothetical concentric quadrangle among the hypothetical concentric quadrangles and second layer fuel rods disposed on the sides of a second largest hypothetical concentric quadrangle among the hypothetical concentric quadrangles; and the outermost fuel rods are disposed so that consecutive outermost fuel rods are set apart from each other over equal intervals which are greater than intervals setting apart consecutive fuel rods among the second layer fuel rods.

According to the 2nd aspect of the present invention, it is preferred that in the fuel assembly according to the 1st aspect the plurality of fuel rods further includes third layer fuel rods disposed on the sides of a third largest hypothetical concentric quadrangle among the hypothetical concentric quadrangles; and the intervals setting apart consecutive fuel rods among the second layer fuel rods are greater than the intervals setting apart consecutive rods among the third layer fuel rods.

According to the 3rd aspect of the present invention, it is preferred that in the fuel assembly according to the 1st aspect the plurality of fuel rods includes standard fuel rods and part-length fuel rods assuming a smaller active fuel length than the standard fuel rods; and the outermost fuel rods are all standard fuel rods.

According to the 4th aspect of the present invention, it is preferred that in the fuel assembly according to the 1st aspect the plurality of fuel rods includes standard fuel rods and part-length fuel rods assuming a smaller active fuel length than the standard fuel rods; and the outermost fuel rods and the second layer fuel rods are all standard fuel rods.

According to the 5th aspect of the present invention, it is preferred that in the fuel assembly according to the 1st aspect, a value obtained by dividing the intervals setting apart consecutive rods among the second layer fuel rods by the intervals setting apart consecutive fuel rods among the outermost fuel rods is greater than 0.93 and smaller than 1.00.

According to the 6th aspect of the present invention, it is preferred that in the fuel assembly according to the 5th aspect, the plurality of fuel rods includes standard fuel rods and part-length fuel rods assuming a smaller active fuel length than the standard fuel rods; and the outermost fuel rods are all standard fuel rods.

According to the 7th aspect of the present invention, a reactor core loaded with a fuel assembly according to any one of the 1st through 6th aspects.

According to the present invention, which achieves both an increase in the quantity of fissile material loaded in the outermost area of the fuel assembly and an improvement in the thermal margin, allows a nuclear reactor to be operated with better efficiency.

### BRIEF DESCRIPTION OF THE DRAWINGS

FIG. 1 schematically illustrates the structure of a boiling water reactor achieved by adopting the fuel assembly and the reactor core according to the present invention.

FIG. 2 is a lateral sectional view of the fuel assembly achieved in a first embodiment.

FIG. 3 shows the structure of the fuel assembly achieved in the first embodiment.

FIG. 4 is a lateral sectional view of the fuel assembly achieved in a second embodiment.

FIG. 5 is a lateral sectional view of the fuel assembly achieved in a third embodiment.

FIG. 6 is a lateral sectional view of the fuel assembly achieved in a fourth embodiment.

FIG. 7 presents a graph of a value (relative value) representing the maximum thermal margin, plotted by varying the ratio P2/P1 of the fuel rod pitches when the output peak of fuel with fissile material loaded in the outermost area is equal to or greater than 1.1.

### DESCRIPTION OF PREFERRED EMBODIMENTS

The inventors of the present invention et. al examined possible measures for improving the combustion efficiency of the fissile material in a fuel assembly. As explained earlier, a great quantity of water (cooling water) is present outside the channel box, and for this reason, maximum efficiency can be achieved through combustion at outermost fuel rods directly facing the channel box (facing the inner walls of the channel box). However, an increase in the quantity of the fissile material loaded in the fuel rods reduces the thermal margin. This issue may be effectively addressed by narrowing the fuel rod pitch for fuel rods located further away from the channel box, which have a greater thermal margin, thus lowering the thermal margin at these fuel rods so as to create room for improving the thermal margin at the outermost fuel rods. In addition, the quantity of fissile material loaded in the outermost fuel rods can be maximized by ensuring that the outermost fuel rods provide uniform output. Based upon these observations, the inventors of the present invention et. al reached the conclusion that a better thermal margin would be achieved in a fuel assembly loaded with a maximum quantity of fissile material by disposing consecutive outermost fuel rods over uniform intervals (with a uniform fuel rod pitch).

Through these measures, the thermal margin of fuel loaded with a greater quantity of fissile material, disposed at the outer edge of the fuel assembly, can be improved. It is to be noted that while the following description of the embodiments primarily focuses on the fuel assembly according to the present invention, the cost efficiency of the plant, too, can be improved by loading such fuel assemblies in the reactor core.

The embodiments of the present invention, achieved by incorporating the rationale discussed above, will be described next.

### First Embodiment

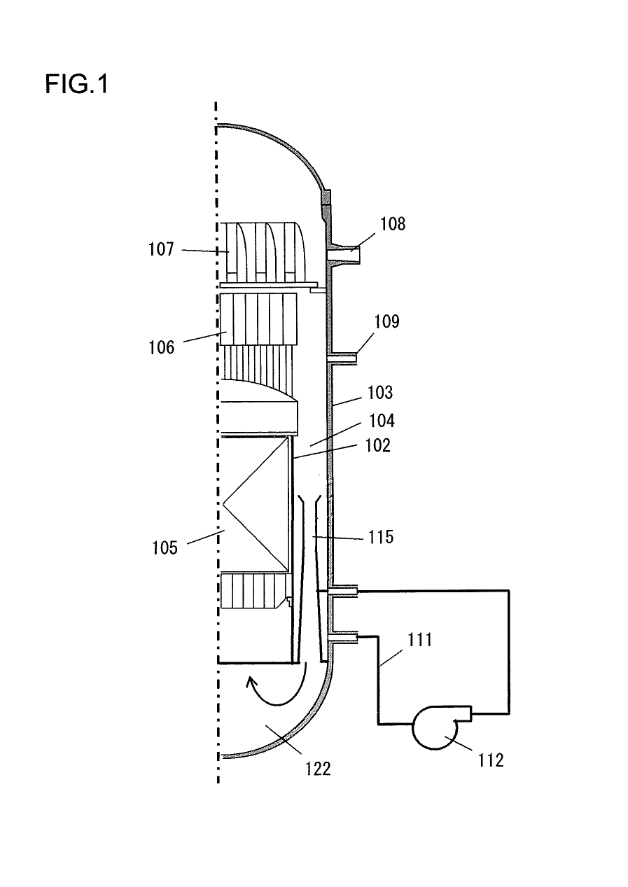

In reference to FIGS. 1 through 3, the fuel assembly and the reactor core achieved in the first embodiment of the present invention will be described. FIG. 1 schematically illustrates the structure of a boiling water reactor adopting the fuel assembly and the reactor core achieved in the embodiment. As FIG. 1 shows, the boiling water reactor (BWR) includes a reactor pressure vessel (reactor vessel) 103. A core shroud 102 is disposed inside the reactor pressure vessel 103. In the following description, the reactor pressure vessel will be referred to as an RPV. A reactor core 105 loaded with a plurality of fuel assemblies, which will be described in detail later, is installed in the core shroud 102. A steam separator 106 and a steam dryer 107 are disposed above the reactor core 105 within the RPV 103. An annular downcomer 104 is formed between the RPV 103 and the core shroud 102. A reactor jet pump 115 is disposed inside the downcomer 104. A recirculation system configured in the RPV 103 includes recirculation system piping 111 and a recirculation pump 112 connected to the recirculation system piping 111.

Cooling water output from a reactor jet pump 115 is provided to the reactor core 105 via a lower plenum 122. As the cooling water passes through the reactor core 105, it becomes heated and thus forms and gas/liquid two-phase flow that includes water and steam. The steam separator 106 separates the gas/liquid two-phase flow into steam and water. The steam, having been separated from the water, is further de-moisturized at the steam dryer 107 and is guided into a main steam pipe 108. The steam is further guided to a steam turbine (not shown) where it causes rotation of the steam turbine. This, in turn, causes rotation of the generator connected to the steam turbine, thereby generating electric power. Steam discharged from the steam turbine is condensed at a condenser (not shown) and is output from the condenser as water. The water condensation is supplied through water supply piping 109 into the RPV 103. The water, having been separated from the steam via the steam separator 106 and the steam dryer 107, travels downward and reaches the downcomer 104 as cooling water.

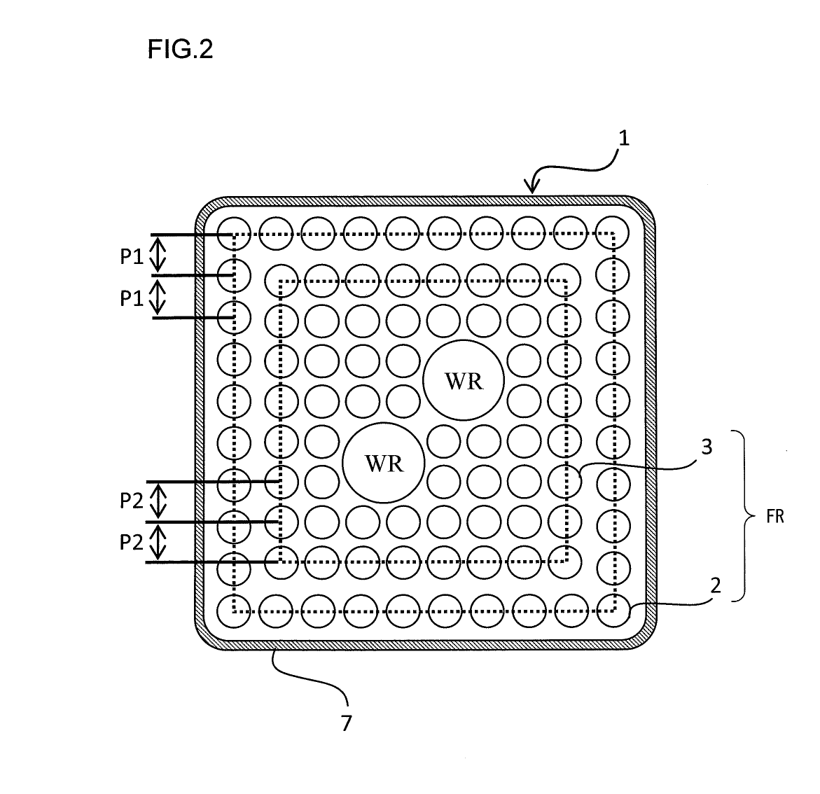

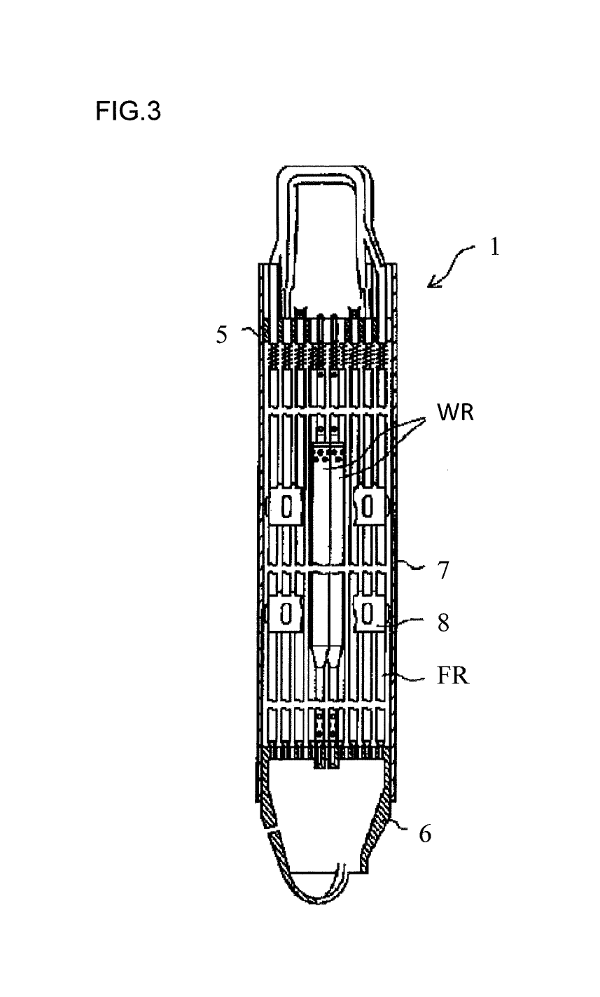

FIG. 2 is a lateral sectional view of a fuel assembly 1 achieved in the embodiment and FIG. 3 shows the structure of the fuel assembly 1. The fuel assembly 1 achieved in the embodiment includes a plurality of fuel rods FR, an upper tie-plate 5, a lower tie-plate 6, a plurality of fuel spacers 8, a plurality of water rods WR and a channel box 7. The fuel rods FR are each formed by charging a plurality of fuel pellets (not shown) into a sheathing tube (not shown) and sealing the sheathing tube. The lower tie-plate 6 supports the individual fuel rods FR at their lower ends, whereas the upper tie-plate 5 supports the fuel rods FR at their upper ends.

The fuel rods FR are disposed in a 10 (rows) by 10 (columns) array, as indicated in the lateral sectional view of the fuel assembly 1 provided in FIG. 2. Two water rods WR are disposed over a central area in the lateral section. The lower ends of the water rods WR are supported by the lower tie-plate 6, whereas their upper ends are held by the upper tie-plate 5. The plurality of fuel spacers 8, disposed over specific intervals along the axis of the fuel assembly 1, hold the fuel rods FR and the water WR so as to form cooling water flow paths through which cooling water flows between the individual fuel rods FR and between the fuel rods FR and the water rods WR.

The channel box 7 is a member assuming a quadrangular duct shape with a square lateral section. The channel box 7, mounted at the upper tie-plate 5, ranges downward. The various fuel rods FR bundled together so as to extend along a uniform direction via the fuel spacers 8 are housed inside the channel box 7. It is to be noted that the channel box 7 assumes an outer dimension of approximately 15 cm measured along the widthwise direction, that the outer diameter of the fuel rods FR is approximately 1.0 cm and that the outer diameter of the water rods WR is approximately 2.5 cm.

The fuel rods FR in the embodiment include fuel rods (standard fuel rods FR-F and part-length fuel rods FR-P) with the areas thereof where fuel pellets containing fissile uranium are loaded assuming different lengths (different active fuel lengths). The active fuel length of the part-length fuel rods FR-P is smaller than that of the standard fuel rods FR-F. The water rods WR, which are large-diameter water rods, have a lateral sectional area large enough to match an area where at least two fuel rods FR can be contained. The standard fuel rods FR-F used in the embodiment have an active fuel length of approximately 3.7 m. It is to be noted that the lateral sectional view in FIG. 2 is taken at a height at which the standard fuel rods FR-F and the part-length fuel rods FR-P are both present. In addition, the outermost fuel rods in the embodiment, which will be described in detail later, are all standard fuel rods FR-F.

Such fuel assemblies 1 are disposed in a regular lattice pattern so that the four side surfaces of the channel box 7 assuming the quadrangular duct shape belonging to a given fuel assembly 1 face opposite the side surfaces of the channel boxes 7 belonging to neighboring fuel assemblies 1 over a specific distance. At the lattice-pattern gaps between the individual fuel assemblies 1, control rods with a lateral section thereof taking a cross shape are disposed. Namely, the fuel assemblies 1 are loaded at the reactor core 105 of the boiling water reactor so that one of the four corners of the channel box 7 assuming the quadrangular duct shape, belonging to each fuel assembly 1, faces opposite the center of a control rod where the two parts of the control rod running along opposite directions intersect each other. In the following description, the corner of a fuel assembly 1 (channel box 7) that faces opposite the intersecting area of a control rod assuming the cross shape may be simply referred to as the “corner facing opposite a control rod”.

The channel boxes 7 are each mounted at the upper tie-plate 5 via a channel fastener (not shown). The channel fasteners have a function of sustaining a necessary clearance over a specific width equivalent to the “specific distance” mentioned earlier between the individual fuel assemblies 1, so as to allow control rods to be inserted between the fuel assemblies 1 loaded into the reactor core 105. In order to fulfill such a function, the channel fasteners are mounted at the upper tie-plate 5 so that they take up corner positions to face opposite the control rods. In other words, the corner of a fuel assembly 1 facing opposite a control rod is where the channel fastener is mounted. The fuel pellets charged into each fuel rod are manufactured by using a nuclear fuel material constituted of uranium dioxide and contain uranium-235, which is a fissile material.

Fuel rods FR indicated by reference numeral 2 are outermost fuel rods 2, which belong to a fuel rod group made up with fuel rods disposed directly next to the inner wall surfaces of the channel box 7. In addition, fuel rods FR indicated by reference numeral 3 are second-layer fuel rods 3 disposed next to the outermost fuel rods 2. Namely, the fuel rods FR disposed in the 10 (rows) by 10 (columns) array in the lateral sectional view of the fuel assembly 1 are set side-by-side on the sides of five hypothetical concentric squares of varying sizes, which are all similar to the sectional shape of the channel box 7, viewed from an end along which the fuel rods FR extend. Namely, the fuel rods FR are disposed in multiple layers along the sides of the hypothetical concentric squares.

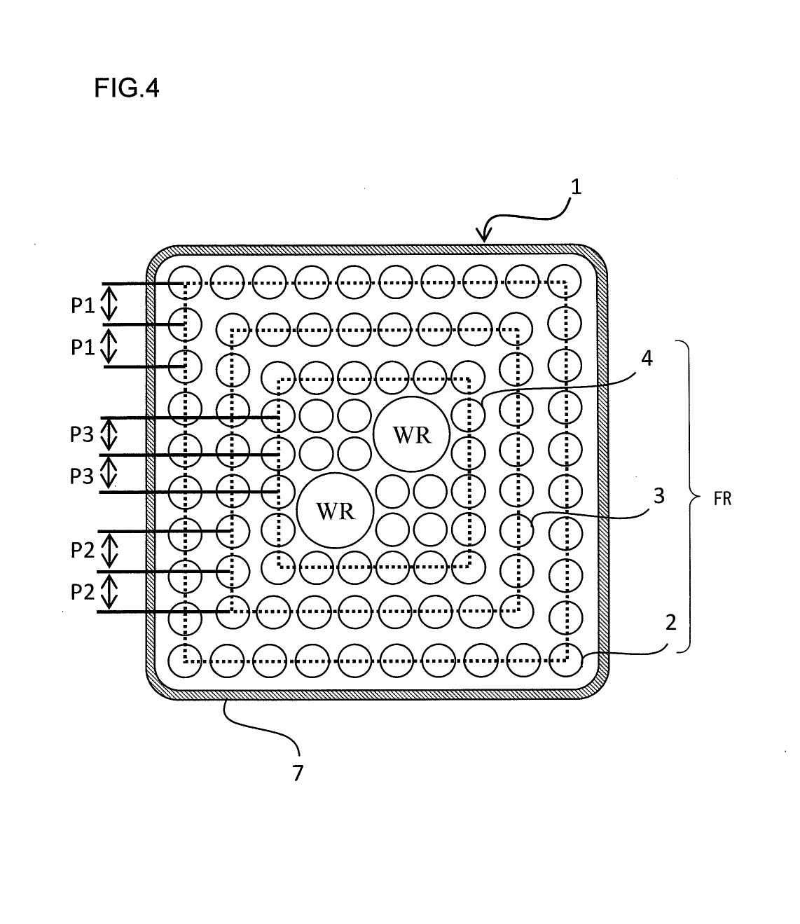

The group of fuel rods disposed on the sides of the largest hypothetical concentric square, (with each side thereof assuming the greatest length), among the five hypothetical concentric squares, are the outermost fuel rod group made up with the fuel rods disposed closest to the inner wall surfaces of the channel box 7. The fuel rods belonging to this fuel rod group will be referred to as outermost fuel rods 2. The fuel rods making up the fuel rod group set on the sides of the second largest hypothetical concentric square (with each side thereof assuming the second greatest length) among the five hypothetical concentric squares are the second layer fuel rods 3. In addition, as indicated in FIG. 4, in reference to which a description will be provided later, fuel rods making up a fuel rod group set on the sides of the third-largest hypothetical concentric square, with each side thereof assuming the third greatest length) among the five hypothetical concentric squares, are third-layer fuel rods 4. In other words, the fuel rods FR are categorized in correspondence to the various sizes of the five hypothetical concentric squares.

The fuel rods FR belonging to a given layer are disposed side-by-side so that successive fuel rods in the group are set apart from each other over equal intervals. In other words, a uniform fuel rod pitch is assumed for each layer. In the embodiment, the fuel rod pitch assumed for the outermost fuel rods 2 is represented by a constant value P1, whereas the fuel rod pitch assumed for the second layer fuel rods 3 is represented by a constant value P2 smaller than P1. As a result, the outermost fuel rods 2 are set apart from the second layer fuel rods 3 over a greater distance. Namely, by setting the fuel rod pitch for the second layer fuel rods 3 to P2 (<P1), the size of the second largest hypothetical concentric square, indicated by a dotted line in FIG. 2, is reduced compared to the size of the second largest hypothetical concentric square formed when the fuel rod pitch for the second layer fuel rods 3 are also set to P1. As a result, the difference between the size of the largest hypothetical concentric square and the second largest hypothetical concentric square, each indicated by a dotted line in FIG. 2 increases widening the distance between the sides of the squares facing opposite each other. This, in turn, allows cooling water to flow through the area between the outermost fuel rods 2 and the second layer fuel rods 3 in greater quantities, thereby securing improved heat removal performance. Consequently, the fissile material can also be loaded in greater quantities in areas of the fuel assembly 1 other than the areas near the corners. In other words, the fissile material can be loaded in greater quantities at the outer edge of the fuel assembly 1 while, at the same time, assuring an improvement in the thermal margin, making it possible to improve the efficiency of the nuclear reactor operation.

It is to be noted that the fuel rods FR in the third layer and subsequent layers may be disposed with fuel rod pitches equal to the fuel rod pitch set for the second layer fuel rods 3, i.e., P2, or they may be disposed with fuel rod pitches other than P2.

### Second Embodiment

In reference to FIG. 4, the second embodiment of the fuel assembly and the reactor core according to the present invention will be described. The following explanation will focus on differences characterizing the second embodiment, with the same reference numerals assigned to structural components identical to those in the first embodiment. Any aspect of the second embodiment not specially noted should be assumed to be identical to that in the first embodiment. The primary feature of the embodiment distinguishing it from the first embodiment is that the fuel rod pitch with which the third layer fuel rods 4 are disposed is smaller than the fuel rod pitch with which the second layer fuel rods 3 are disposed.

In the fuel assembly 1 achieved in the second embodiment, the fuel rod pitch for the third layer fuel rods 4 is represented by a constant value P3 which is smaller than P2 representing the fuel rod pitch with which the second layer overrides 3 are disposed, so as to widen the distance setting apart the second layer from the third layer. In the related art, the thermal margin at the fuel rods in the second layer is smaller than that of the fuel rods in the third layer, provided that the output peak rises at a fuel rod closer to the outer edge (i.e., closer to an inner wall surface of the channel box 7). Accordingly, the thermal margin at the fuel assembly 1 can be improved by widening the distance between the second layer and the third layer as in the embodiment, which, in turn, makes it possible to keep up the quantity of fissile material loaded in the second layer fuel rods. As a result, both an increase in the quantity of fissile material loaded in the fuel assembly 1 (in particular, over the outermost area thereof) and an improvement in the thermal margin are achieved, leading to better efficiency in nuclear reactor operation.

### Third Embodiment

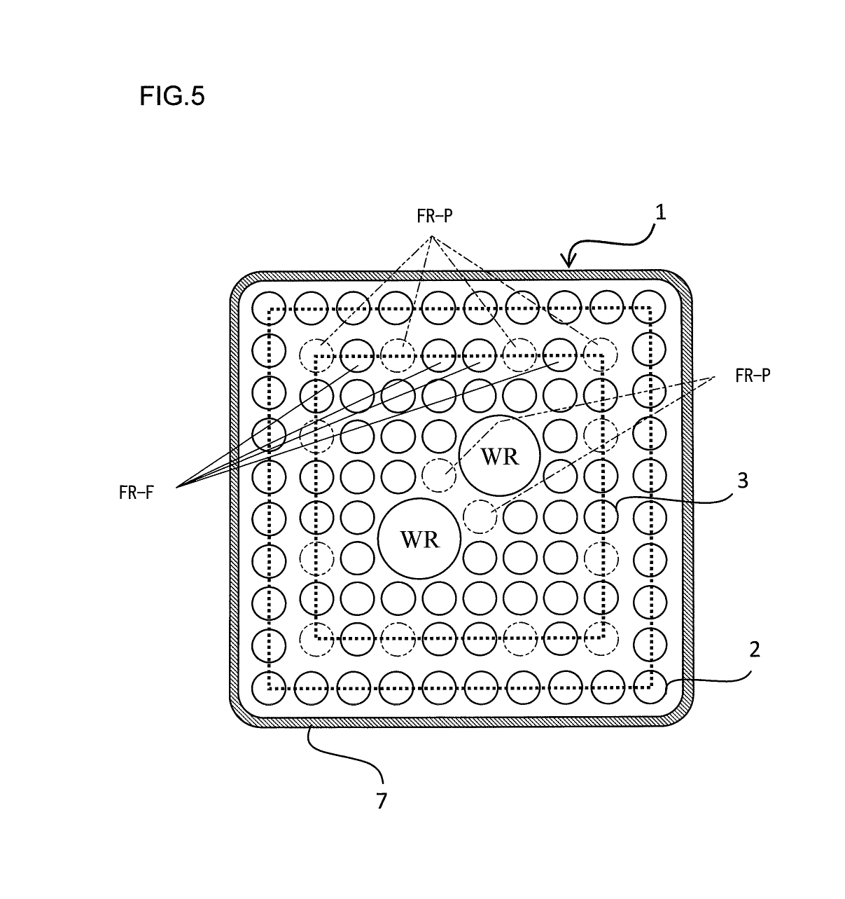

In reference to FIG. 5, the third embodiment of the fuel assembly and the reactor core according to the present invention will be described. The following explanation will focus on differences characterizing the third embodiment, with the same reference numerals assigned to structural components identical to those in the first embodiment. Any aspect of the third embodiment not specially noted should be assumed to be identical to that in the first embodiment. The primary feature of the embodiment distinguishing it from the first embodiment is that part-length fuel rods FR-P are disposed in the second layer and a subsequent layer (the second layer and a layer present further inward relative to the second layer).

FIG. 5 presents a lateral sectional view of the fuel assembly 1 achieved in the embodiment, which is taken at a height at which the standard fuel rods FR-F are present but the part length fuel rods FR-P are not present. In FIG. 5, the standard fuel rods FR-F are indicated by solid-line circles and the part-length fuel rods FR-P are indicated by 2-point chain line circles. In the fuel assembly 1 achieved in the embodiment, the fuel rods in the second layer and beyond are disposed with a fuel rod pitch smaller than that set for the outermost layer fuel rods with part-length fuel rods FR-P disposed in the second layer and beyond. In other words, the outermost fuel rods 2 are all standard fuel rods FR-F. It is to be noted that in the example presented in the lateral sectional view in FIG. 5, some of the second layer fuel rods 3 and the two fuel rods FR forming the fifth layer are part-length fuel rods FR-P.

The fuel assembly 1 has the least margin (thermal margin) in heat removal performance over its upper area where the quality is significant. It is to be noted that the term “quality” is used to refer to the ratio of gas in a flow in which gas and liquid are mixed, represented by the mass ratio of the gas. As described earlier, FIG. 5 shows the fuel assembly 1 achieved in the embodiment in a lateral sectional view taken at a height at which the part-length fuel rods FR-P are not present. In other words, at the height at which the lateral sectional view in FIG. 5 is taken, there are no fuel rods FR present directly above the part-length fuel rods FR-P indicated by the 2-point chain lines and the space directly above the part-length fuel rods FR-P forms cooling water distribution paths.

As a result, the area where the cooling water flows further inward relative to the outermost fuel rods can be further increased in the embodiment. Consequently, the heat removal performance can be further improved, which, in turn, leads to both an increase in the quantity of fissile material that can be loaded and an improvement in the thermal margin, allowing the nuclear reactor to be operated with better efficiency.

It is to be noted that the fuel assembly in the second embodiment described earlier may include part-length fuel rods FR-P disposed in the second layer and beyond as in the third embodiment so as to achieve additional advantages similar to those of the third embodiment.

### Fourth Embodiment

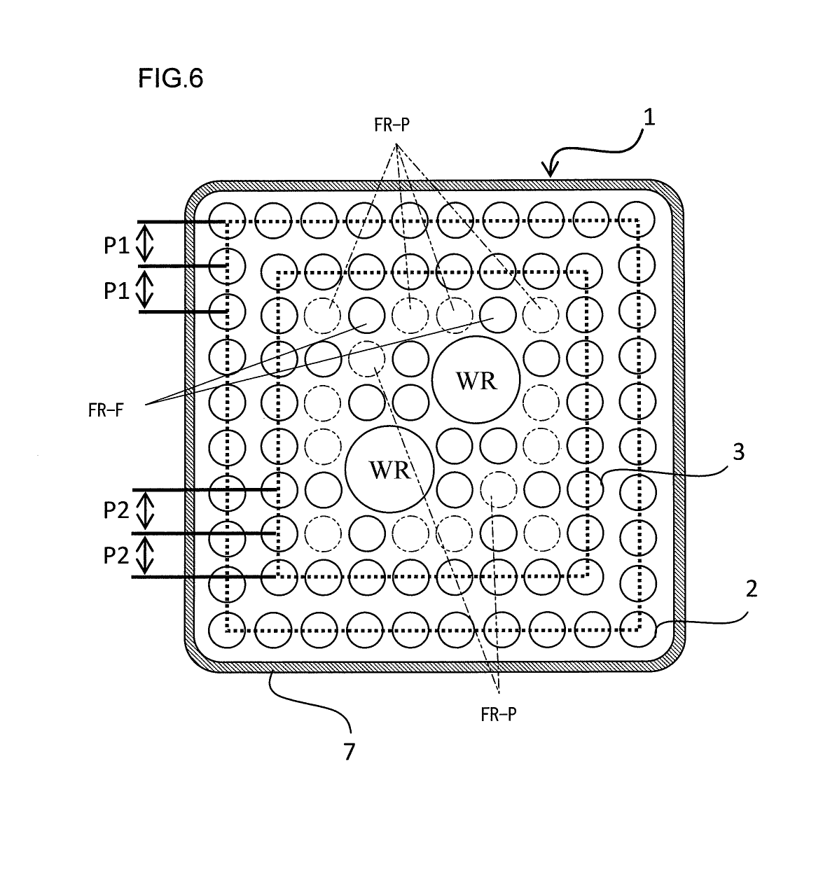

In reference to FIG. 6, the fourth embodiment of the fuel assembly and the reactor core according to the present invention will be described. The following explanation will focus on differences characterizing the fourth embodiment, with the same reference numerals assigned to structural components identical to those in the first embodiment. Any aspect of the fourth embodiment not specially noted should be assumed to be identical to that in the first embodiment. The primary feature of the embodiment distinguishing it from the first embodiment is that part-length fuel rods FR-P are disposed in the third layer and a subsequent layer (the third layer and a layer present further inward relative to the third layer).

FIG. 6 presents a lateral sectional view of the fuel assembly 1 achieved in the embodiment, which is taken at a height at which the standard fuel rods FR-F are present but the part-length fuel rods FR-P are not present. In FIG. 6, the standard fuel rods FR-F are indicated by solid line circles and the part-length fuel rods FR-P are indicated by 2-point chain line circles. With the part-length fuel rods FR-P disposed in the third layer and beyond, the outermost fuel rods and the second layer fuel rods can be all made up with standard fuel rods FR-F. This layout makes it possible to increase the quantities of fissile material loaded in the outermost layer fuel rods and the second layer fuel rods FR while, at the same time, assuring improved heat removal performance at the outermost fuel rods FR and the second layer fuel rods FR. Consequently, through the embodiment achieving both an increase in the quantity of fissile material that can be loaded in the fuel assembly and an improvement in the thermal margin, better efficiency in nuclear reactor operation is assured.

It is to be noted that the fuel assembly in the second embodiment described earlier may include part-length fuel rods FR-P disposed in the third layer and beyond as in the third embodiment so as to achieve additional advantages similar to those of the third embodiment.

### Fifth Embodiment

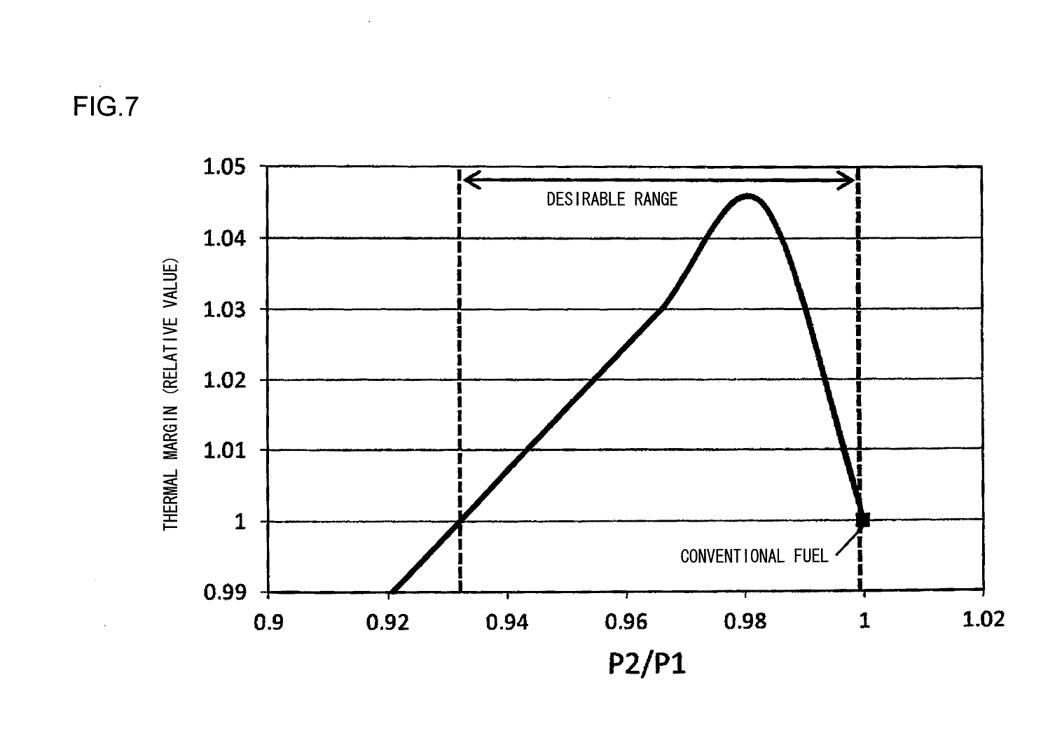

In reference to FIG. 7, the fifth embodiment of the fuel assembly and the reactor core according to the present invention will be described. The following explanation will focus on differences characterizing the fifth embodiment, with the same reference numerals assigned to structural components identical to those in the first embodiment. Any aspect of the fifth embodiment not specially noted should be assumed to be identical to that in the first embodiment. The primary feature of the embodiment distinguishing it from the first embodiment is that the ratio of the value P1 representing the fuel rod pitch set for the outermost fuel rods 2 and the value P2 representing the fuel rod pitches set for the second layer fuel rods 3 is defined as follows.

FIG. 7 presents a graph of a value (relative value) representing the maximum thermal margin plotted by varying the ratio P2/P1 of the fuel rod pitches when the output peak of the fuel with fissile material loaded in the outermost area is equal to or greater than 1.1. The ratio P2/P1 of the fuel rod pitches is obviously the value obtained by dividing the interval over which each two consecutive fuel rods among the second layer fuel rods 3 are set apart from each other by the interval setting apart each two consecutive fuel rods among the outermost fuel rods 2.

As explained earlier, a greater thermal margin compared to that in a fuel assembly in the related art (conventional fuel) is created by setting P2, representing the fuel rod pitch for the second layer fuel rods 3, to a value smaller than P1 representing the fuel rod pitch for the outermost fuel rods 2. However, if the ratio P2/P1 of the fuel rod pitches is set to a value smaller than a certain value, the thermal margin at the second layer fuel rods 3 will become smaller than the thermal margin at the outermost fuel rods, resulting in a smaller overall thermal margin. As FIG. 7 indicates, when the ratio P2/P1 falls into the range of 0.93<P2/P1<1.00, a thermal margin equal to or greater than that of the conventional fuel is achieved. Accordingly, it is desirable that the ratio P2/P1 of the fuel rod pitches be greater than 0.93 and smaller than 1.00. In particular, an improvement in the thermal margin by 4% or more over the conventional fuel can be achieved by setting P2/P1 to 0.98. Through the embodiment with the ratio P2/P1 defined as described above, both an increase in the quantity of fissile material that can be loaded in the fuel assembly and an improvement in the thermal margin can be effectively achieved, thereby allowing the nuclear reactor to be operated with better efficiency.

(1) In the first and second embodiments described above, the fuel rods FR include standard fuel rods FR-F and part-length fuel rods FR-P assuming different active fuel lengths. However, the present invention is not limited to this example. Namely, the first and second embodiments may be achieved in conjunction with, for instance, fuel rods FR that are all standard fuel rods FR-F.

(2) While the fuel assembly 1 is loaded into the reactor core 105 of a boiling water reactor in the embodiments described above, the present invention is not limited to this example. Types of nuclear reactors into which the fuel assembly 1 may be loaded include; light water reactors such as an advanced boiling water reactor and a pressurized water reactor, or it may be loaded into heavy water reactors

(3) While the fuel pellets charged into each fuel rod FR contain uranium-235 as the fissile material in the description provided above, the present invention is not limited to this example and it may be adopted in conjunction with fuel pellets containing, for instance, fissile plutonium.

(4) The embodiments and the variations thereof described above may be adopted in any combination.

It is to be noted that the present invention is not limited to the particulars of the embodiments described above and fuel assemblies each adopting any of various structures, with a plurality of fuel rods extending in a uniform direction disposed inside a channel box assuming a quadrangular duct shape, characterized in that the plurality of fuel rods that are disposed on sides of a plurality of hypothetical concentric quadrangles of various sizes with shapes similar to a sectional shape of the channel box viewed from an end along which the fuel rods extend, and include at least outermost fuel rods disposed on the sides of a largest hypothetical concentric quadrangle among the hypothetical concentric quadrangles and second layer fuel rods disposed on the sides of a second largest hypothetical concentric quadrangle among the hypothetical concentric quadrangles and that the outermost fuel rods are disposed so that consecutive outermost fuel rods are set apart from each other over equal intervals which are greater than intervals setting apart consecutive fuel rods among the second layer fuel rods, and reactor cores each adopting any of various structures, into which the fuel assembly is loaded, are all within the scope of the present invention.

The above-described embodiments are examples and various modifications can be made without departing from the scope of the invention.

What is claimed is:

1. A fuel assembly with a plurality of fuel rods, extending along a uniform direction, disposed inside a channel box assuming a quadrangular duct shape, wherein:
the plurality of fuel rods that are disposed on sides of a plurality of hypothetical concentric quadrangles of various sizes with shapes similar to a cross-sectional shape of the channel box viewed from an end along which the fuel rods extend, and include at least outermost fuel rods disposed on the sides of a largest hypothetical concentric quadrangle among the hypothetical concentric quadrangles and second layer fuel rods disposed on the sides of a second largest hypothetical concentric quadrangle among the hypothetical concentric quadrangles; and
the outermost fuel rods are disposed so that consecutive outermost fuel rods are set apart from each other over equal intervals which are greater than intervals setting apart consecutive fuel rods among the second layer fuel rods.

2. A fuel assembly according to claim 1, wherein:
the plurality of fuel rods further includes third layer fuel rods disposed on the sides of a third largest hypothetical concentric quadrangle among the hypothetical concentric quadrangles; and
the intervals setting apart consecutive fuel rods among the second layer fuel rods are greater than the intervals setting apart consecutive rods among the third layer fuel rods.

3. A fuel assembly according to claim 1, wherein:
the plurality of fuel rods includes standard fuel rods and part-length fuel rods assuming a smaller active fuel length than the standard fuel rods; and
the outermost fuel rods are all standard fuel rods.

4. A fuel assembly according to claim 1, wherein:
the plurality of fuel rods includes standard fuel rods and part-length fuel rods assuming a smaller active fuel length than the standard fuel rods; and
the outermost fuel rods and the second layer fuel rods are all standard fuel rods.

5. A fuel assembly according to claim 1, wherein:
a value obtained by dividing the intervals setting apart consecutive rods among the second layer fuel rods by the intervals setting apart consecutive fuel rods among the outermost fuel rods is greater than 0.93 and smaller than 1.00.

6. A fuel assembly according to claim 5, wherein:
the plurality of fuel rods includes standard fuel rods and part-length fuel rods assuming a smaller active fuel length than the standard fuel rods; and
the outermost fuel rods are all standard fuel rods.

7. A reactor core loaded with a fuel assembly according to claim 1.

8. A reactor core loaded with a fuel assembly according to claim 2.

9. A reactor core loaded with a fuel assembly according to claim 3.

10. A reactor core loaded with a fuel assembly according to claim 4.

11. A reactor core loaded with a fuel assembly according to claim 5.

12. A reactor core loaded with a fuel assembly according to claim 6.
